(19) United States
(12) Patent Application Publication
(10) Pub. No.: US 2014/0317301 A1
(43) Pub. Date: Oct. 23, 2014

(54) SYSTEMS AND METHODS FOR ESTABLISHING TELECOMMUNICATION CONNECTION BETWEEN A REQUESTER AND AN INTERPRETER

(71) Applicant: Gold Post Technologies, Inc., Las Vegas, NV (US)

(72) Inventors: Quyen Kiet, Las Vegas, NV (US); Uttam Shah, Torrance, CA (US); Barry Goldstein, Las Vegas, NV (US)

(73) Assignee: Gold Post Technologies, Inc., Las Vegas, NV (US)

(21) Appl. No.: 14/255,878

(22) Filed: Apr. 17, 2014

Related U.S. Application Data
(60) Provisional application No. 61/812,819, filed on Apr. 17, 2013.

(51) Int. Cl. H04L 29/08

(52) U.S. Cl. CPC H04L 67/141
USPC 709/227

(57) ABSTRACT

A representative telecommunication system that establishes communication between an interpreter and a requester is disclosed herein comprising a plurality of computing devices associated with at least one interpreter and at least one requester; a network that interconnects the plurality of computing devices; and a match server that is interconnected to the plurality of computing devices by way of the network. The match server includes a processing device, and memory including an match manager which has instructions that are executed by the processing device. The instructions include the following logics: establish connection between the match server and the computing device associated with the interpreter; assess a request for an interpreter having at least one language interpretation and for an availability of the interpreter; and establish a telecommunication connection between the plurality of the computing devices associated with the interpreter and requester based on the connection established between the match server and the computing device associated with the interpreter, and the assessment of the request for the interpreter having the at least one language interpretation and for an availability of the interpreter.

### CROSS REFERENCE TO RELATED APPLICATIONS

This application claims the benefit of U.S. provisional application entitled, “System For and Method of One-Click Service Request, Supplier Matching and Service Delivery,” having Ser. No. 61/812,819, filed on Apr. 17, 2013, all of which are entirely incorporated herein by reference.

### TECHNICAL FIELD

The present disclosure is generally related to telecommunication systems and, more particularly, is related to systems and methods for establishing communication between an interpreter and a requester.

### BACKGROUND

The world is becoming more global and diverse, specifically in commerce. As such, the language translation industry is in more demand. Traditionally, a requester contacts a language translation company and requests for a translator/interpreter at a particularly time and date, and sometimes at a specific location.

Desirable in the art is an improved method of matching a requester and interpreter that would improve upon the conventional method.

### SUMMARY

A representative telecommunication system that establishes communication between an interpreter and a requester is disclosed herein comprising a plurality of computing devices associated with at least one interpreter and at least one requester; a network that interconnects the plurality of computing devices; and a match server that is interconnected to the plurality of computing devices by way of the network. The match server includes a processing device, and memory including a match manager which has instructions that are executed by the processing device. The instructions include the following logics: establish connection between the match server and the computing device associated with the interpreter; assess a request for an interpreter having at least one language interpretation and for an availability of the interpreter; and establish a telecommunication connection between the plurality of the computing devices associated with the interpreter and requester based on the connection established between the match server and the computing device associated with the interpreter, and the assessment of the request for the interpreter having the at least one language interpretation and for an availability of the interpreter.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram that illustrates an embodiment of a system having a match manager that allows a requester to establish a telecommunication connection with an interpreter via a network;

FIG. 2 is a high-level block diagram that illustrates an embodiment of an interpreter-requester match system, such as that shown in FIG. 1;

FIG. 3 is a sequence diagram that illustrates an embodiment of an interpreter-requester match system, such as that shown in FIG. 2;

FIG. 4 is a flow diagram that illustrates an embodiment of the architecture, functionality, and/or operation of a match manager, such as that shown in FIG. 1;

FIG. 5 is a more detailed flow diagram that illustrates an embodiment of the architecture, functionality, and/or operation of a request assessment module 215, such as that shown in FIG. 2;

FIG. 6 is a more detailed flow diagram that illustrates an embodiment of the architecture, functionality, and/or operation of a connection quality delivery module 225, such as that shown in FIG. 2;

FIG. 7 is a more detailed flow diagram that illustrates an embodiment of the architecture, functionality, and/or operation of a product assessment module 205, such as that shown in FIG. 2; and

FIG. 8 is a block diagram illustrating an exemplary architecture for a generic computer that is similar to the architecture of the computing device, local server and central server having a match manager, such as that shown in FIG. 1.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which a match server establishes telecommunication connection between a requester and an interpreter.

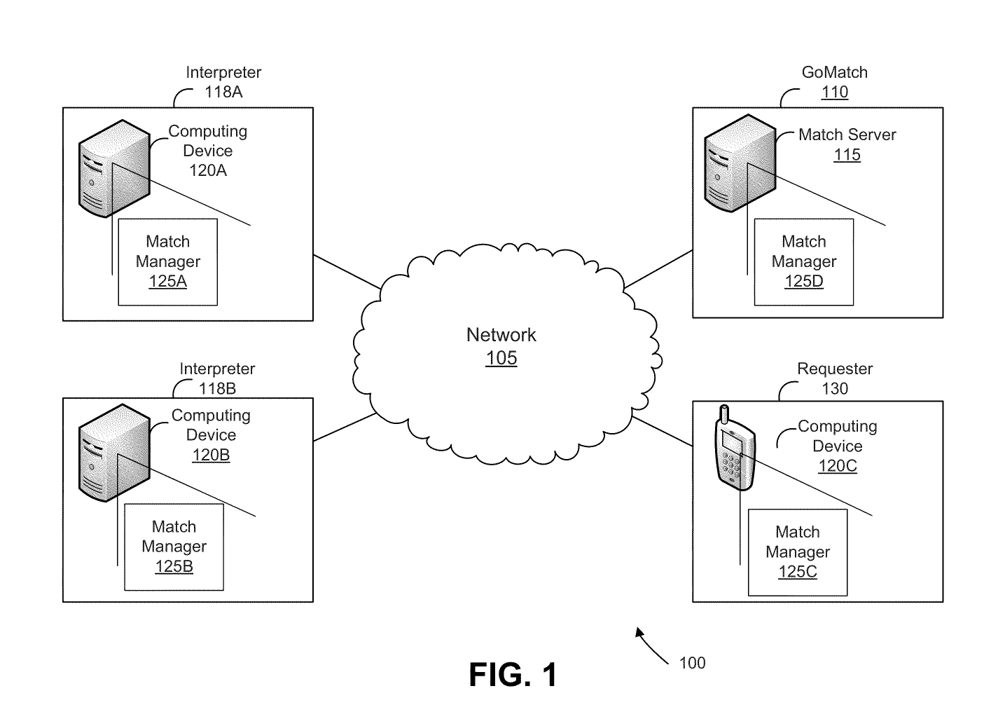

FIG. 1 is a block diagram that illustrates an embodiment of a system 100 having a match manager 125 that allows a requester 130 to establish a telecommunication connection with an interpreter 118 via a network 105. The system 100 can include match server 115 at a premise of a GoMatch Entity 110, and computing devices 120A-B and portable computing devices 120C at respective premises 118, 130A-B of an interpreter 118 and requesters 130A-B. The computing devices 120A-C can include, but not limited to, desktop computers, laptops, netbooks, smart phones, tablets, smart glass, and smart watch.

Each match server 115 and computing devices 120A-C is installed with a match manager 125A-D. The computing devices 120A-C can communication with the match server 115 via the network 105, e.g., Internet, LAN, and WAN. The match manager 125 can aide a requester 130 to establish a telecommunication connection (e.g., voice or video connection) with an interpreter 118. The match manager 125 is further described in connection to the later FIGS.

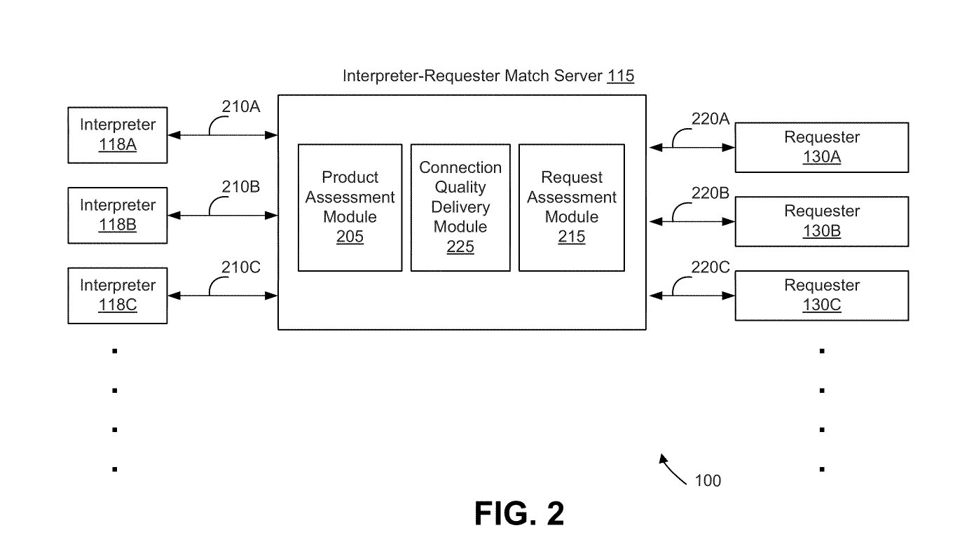

FIG. 2 is a high-level block diagram that illustrates an embodiment of an interpreter-requester match server 115, such as that shown in FIG. 1. A plurality of interpreters 118A-C and a plurality of requesters 130A-C can communicate with the interpreter-requester match server 115 via lines 210A-C, 220A-B, respectively, through their respective computing devices 120A-C, such as smartphones (e.g. iPhone devices, Android devices, Windows Mobile), personal computers or hand held tablet devices (e.g. iPad, Galaxy Note, Microsoft Surface, etc.) or networking clients (e.g. Ethernet LAN), for example. The computing devices 120A-C can communicate with the interpreter-requester match server 115 by Internet connection (e.g. TCP/IP framework) or private network (e.g. Ethernet LAN or wireless LAN), for example.

Each computing device 120 has functional modules (Interface Device, I/O Device, Network Device, Processing Device, etc.) that enable the user to communicate with the interpreter-requester match server 115. On their respective computing devices 120, each requester 130 selects the language of choice based on their unique needs (e.g. Spanish Legal, Spanish Medical, etc.) by interacting with their computing device 120, which is transmitted to the interpreter-requester match server 115 for processing by a product assessment module 205, connection quality delivery module 225, and request assessment module 215, which is described in more detailed in connection to the later FIGS.

The requesters 130A-C who need language interpretation services would register with the interpreter-requester match server 115, and the payment arrangements already secured ahead of time. Interpreters 118A-C who wish to provide translation services also register with interpreter-requester match server 115 and their compensation arranged ahead of time.

After the requesters 130A-C and interpreters 118A-C have registered with interpreter-requester match server 115, they can have access to the various interface portals on numerous devices (such as desktop PC browser, website, native smartphone app, tablet app, in-car network like OnStar™). Because the requesters 130A-C have already pre-arranged the service pricing and payment process ahead of time, there is no need for the requesters 130A-C to negotiate pricing or payment when seeking interpreter services. Similarly, because registered interpreters 118A-C have already pre-arranged their compensation and payment procedure, there is no need for interpreters 118A-C to worry about payment terms when accepting a service request.

In an example, when the requester 130A seeks Spanish interpretation service, requester 130A can access the smartphone app and request for a Spanish-English interpreter 118 for immediate delivery of service. The interpreter-requester match server 115 can alert any available Spanish interpreters of this request on their respective smartphone apps. Among the interested interpreters who agreed to provide the requested service, interpreter-requester match server 115 can select a single interpreter 118 to match with the requester 130A based on criteria that the requester 130A requested, which is described in more detailed in connection to the later FIGS. Once the match is made the interpreter-requester match server 115 can proceed to establish a telecommunication connection between the interpreter 118A and the requester 130A via the interpreter-requester match system. The telecommunication connection can include video and/or audio teleconference.

The interpreter-requester match server 115 can be advantages in situations where the requesters 130A-C are seeking Spanish interpreters on demand. Further, rather than advising the remaining interpreters 118A-C that their services are no longer needed at the end of a language interpretation session, the interpreter-requester match server 115 can keep track of how many interpreters 118A-C are available for service, and continues to match them to the barrage of Spanish language requests from the multiple requesters 130A-C. Similarly, if interpreter-requester match server 115 determines that there are not enough interested interpreters 118A-C to fulfill the number of requestors 130A-C within a timeframe, it can alert additional interpreters 130A-C not previously alerted. This process continues until either all requests have been fulfilled or until the given time period expires and the requestor 130A is advised that there are no interpreters 118A-C available to deliver the service within the requested time frame.

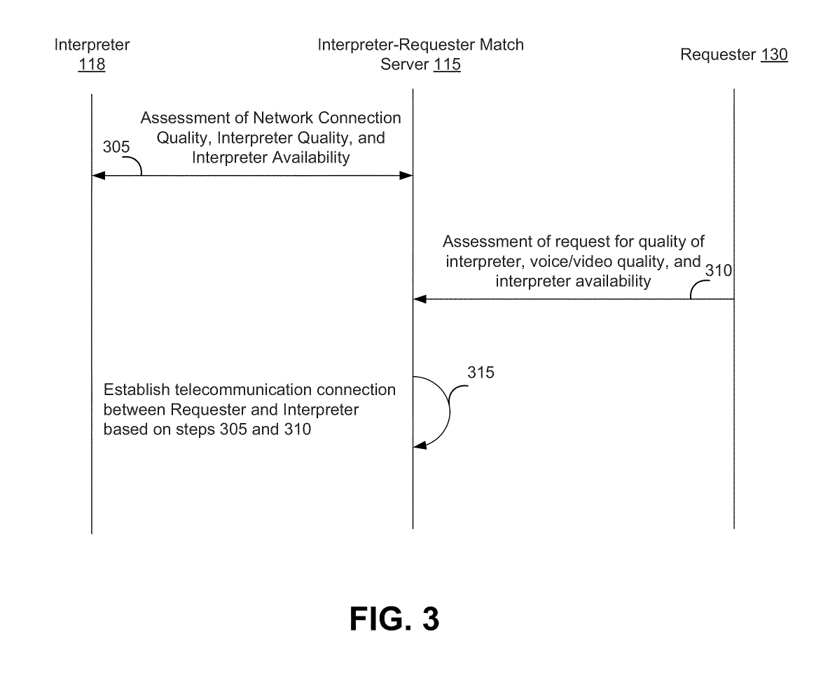

FIG. 3 is a sequence diagram that illustrates an embodiment of an interpreter-requester match system 215, such as that shown in FIG. 2. Beginning with line 305, an interpreter 118 using his/her computer device 120 establishes connection with an interpreter-requester match server 115, which in turn can assess the quality of the network connection between the match server and the interpreter 118, and the quality and availability of the interpreter. At line 310, the requester 130 using his/her computer device 120 establishes connection with the interpreter-requester match server 115, which in turn can assess the request for a certain quality and availability of the interpreter, and certain quality of voice/video teleconference with the interpreter. At line 315, the interpreter-requester match server 115 established a telecommunication connection between the interpreter 118 and the requester 130 based on any one of the operations and/or results of steps 305 and 310.

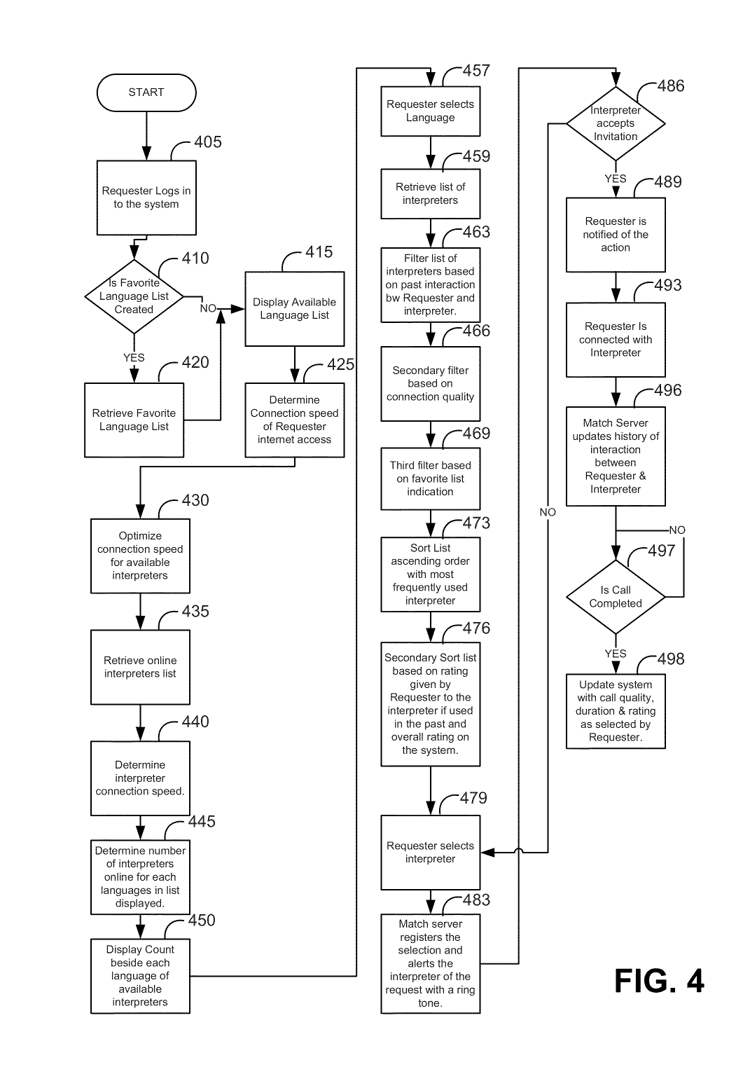

FIG. 4 is a flow diagram that illustrates an embodiment of the architecture, functionality, and/or operation of a match manager 125, such as that shown in FIG. 1. Beginning with block 405, requester 130 logs into the interpreter-requester match server 115. In block 410, the interpreter -requester match server 115 determines whether a favorite language list was created for the requester 130. If yes, in blocked 420, the match server 115 retrieves the favorite claim which lists. If not, in blocked 415, the match server 115 displays available language list for the requester 130 to select from. In block 425, the match server 115 determines a network connection speed of the Internet access of the requestor 130.

In blocks 430 and 435, the match server 115 optimizes the network connection speed for available interpreters 118 that have established connection with the match server 115, and retrieves a list of interpreters that are online with respect to the match server 115. In blocks 440 and 445, the match server 115 determines the network connection speed of the interpreter 118 and the number of interpreters 118 that our online for each language in the list displayed. In block 450, the match server 115 displays the number of available interpreters 118 next to each language interpretation. In block 457, the requestor 130 selects a desired language. In blocks 459 and 463, the match server 115 retrieves a list of available interpreters 118 and filters the list of interpreters 118 based on past interaction between the requestor 130 and the interpreter 118. In blocks 466 and 469, the match server 115 can perform a secondary filter that is based on the network connection speed and/or quality and based on a favor list invitation.

In blocks 473 and 476, the match server 115 sorts the list of available interpreters 118 an ascending order starting with the most frequently use interpreter 118, and sorts the list of available interpreters 118 based on a rating given by the requestor 130 to the interpreter 118 if the requester 130 used the interpreter 118 in the past and based on the overall rating of the interpreter 118 stored in the match server 115. In block 479, the requester 130 selects his or her desired interpreter 118 from the list of interpreters 118. In block 483, the match server 115 registers this selection and alerts the selected interpreter 118 of their requests with for example a ringing tone or visible graphic message, on his or her smart phone.

In block 486, the match server 115 determines whether the interpreter 118 accepted the invitation from the match server 118 to perform a language interpretation service. Responsive to the interpreter 118 declining the invitation, the operation proceeds to block 479 where the requestor 130 can select another interpreter 118. Responsive to the interpreter accepting the invitation, the match server 115 notifies the requestor 130 that the interpreter 118 accepted the invitation. At block 493, the match the server 115 establishes a telecommunication connection between the requestor 130 and the interpreter 118. At block 496, the match server 115 updates the history of interaction between the requester 130 and the interpreter 118. And block 497, the match server 115 determines whether the telecommunication connection has ended between the requestor 130 and the interpreter 118. If not, the match server 115 continues to monitor whether the telecommunication connection has ended. If yes, the match server 115 updates the profile of the requestor with respect to his or her selected call quality, call duration, and rating of the interpreter 118.

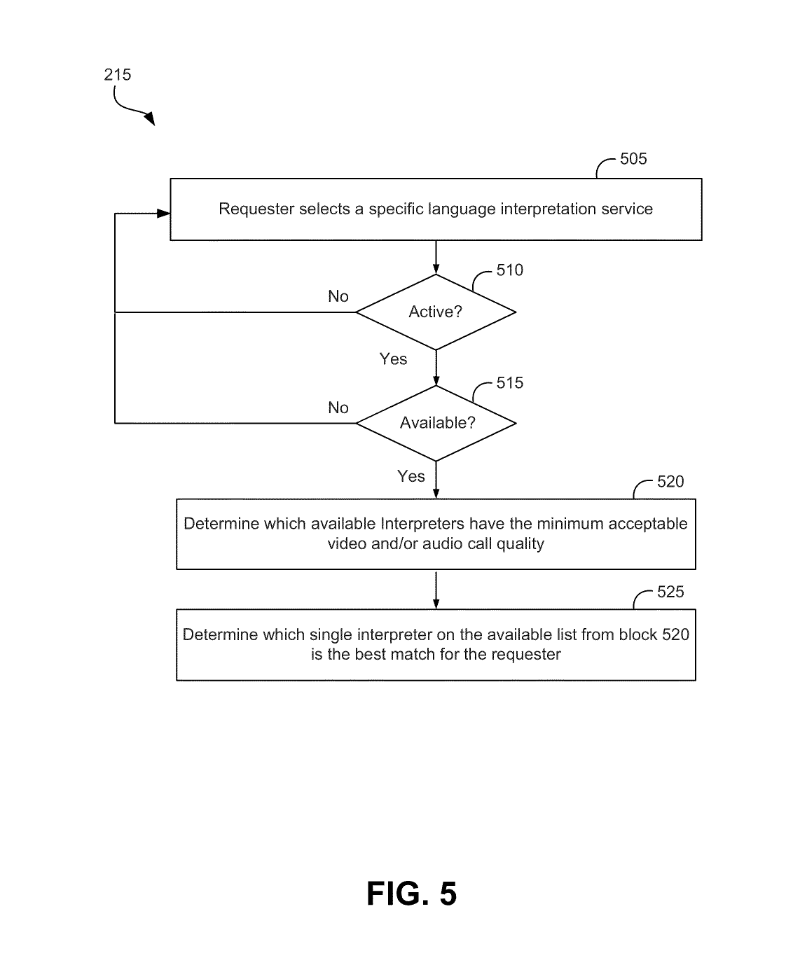

FIG. 5 is a more detailed flow diagram that illustrates an embodiment of the architecture, functionality, and/or operation of a request assessment module 215, such as that shown in FIG. 2. Interpreters 118 who are available to be connected to a prospective requester 130 registers their status as “active” on their computing device 120. The interpreters 118 can also register their specific language skills (e.g. Spanish Legal, Mandarin Medical, etc.) into the interpreter-requester match server 115, which stores the language skills of registered interpreters 118 and also maintains a record of “active” interpreters 118 with established connection with the interpreter-requester match server 115 until either the interpreters 118 deselect their “active” status or are disconnected from the interpreter-requester match server 115 for a specified period of time, after which interpreter-requester match server 115 automatically changes the interpreter's status to “inactive.” Active interpreters 118 can be designated as either “active and available” or “active and unavailable”. “Active and available” refers to an interpreter 118 who is connected to the interpreter-requester match server 115 and waiting to be connected to a requester 130. “Active and unavailable” refers to an interpreter who is connected to the interpreter-requester match server 115 but already connected to a Requester to render interpreting service.

At block 505, the requester 130 selects a specific language interpretation service having a certain background/experience (e.g. Spanish Legal, Mandarin Medical, etc.), which is transmitted to the request assessment module 215, which determines whether that specific interpreter 118 is “active”. At block 510, the request assessment module 215 receives the requester's selection and determines whether there are any interpreters 118 with the requested skill who are “active”. If there are no interpreters with the requested service who are either “active”, the request assessment module 215 can communicate to the requester 130 that the requested interpreter 118 is not available at this time for connection and requests that the requester 130 for another language interpretation service. If there are interpreters 118 who are “active”, the request assessment module 215 at block 515 determines whether there are any active interpreters 118 with the requested skill who are “available”.

Responsive to the request assessment module 215 determining that the active interpreters 118 with the requested background/experience are “active and unavailable” then the request assessment module 215 estimates when these “active and unavailable” interpreters 118 would be available, and communicates this estimation to the requester 130. The estimation is calculated using the appropriate algorithm that incorporates historical usage times of the individual requesters. Responsive to the request assessment module 215 determining that the active interpreters 118 are “active and available” then the request assessment module 215 at block 520 determines which available interpreters 118 have the minimum acceptable video and/or audio call quality using the Product Connection Quality Delivery Module 225. The request assessment module 215 ranks the interpreters in a list based on the acceptable video and/or audio call quality, and filters and selects the interpreters who exceed the minimum acceptable call quality.

At block 525, from the list provided in block 520, the request assessment module 215 determines which single interpreter 118 on the available list from block 520 is the best match for the requester 130 using the Interpreter Quality Assessment Module 205. Such module 205 assesses and scores the interpreters 118 for service quality based on past ranking with this particular requester 130 and past rankings with other requesters 130, then selects the single interpreter 118 with the highest score using the specified algorithm for this purpose based on service quality. The request assessment module 215 establishes telecommunication connection between the selected interpreter 118 and the requester 130.

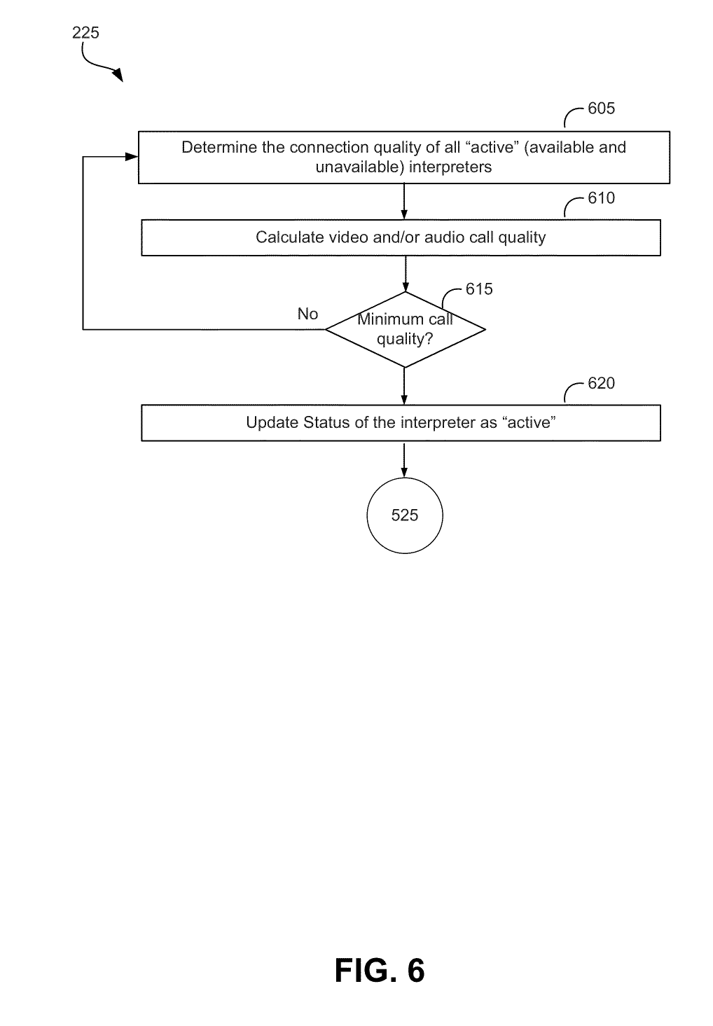

FIG. 6 is a more detailed flow diagram that illustrates an embodiment of the architecture, functionality, and/or operation of a connection quality delivery module 225, such as that shown in FIG. 2. At block 605, the connection quality delivery module 225 determines the connection quality of all “active” (available and unavailable) interpreters 118 and assigns it a score. There is a specified minimum acceptable video and/or audio call quality score that is predetermined by the System administrator against which the interpreter telecommunication connection scores are compared.

At block 610, the module 225 receives the connection request from interpreters 118 (FIG. 2, 210A, 210B, etc.), and before registering them as “Active”, the module 225 calculates their respective video and/or audio call quality by determining the average bit rate and/or connection speed between each interpreter 118 and the match server 115. At block 615, the connection quality is available for evaluation when the interpreter 118 establishes connection with the match server 115 via the Internet. If the call quality is below the minimum acceptable score, the match server 115 communicates to the interpreter 118 that no connection can be made until the interpreter 118 improves the connection quality.

The interpreter 118 who is denied connection due to low quality may attempt to reconnect until the match server 115 determines that the call quality of the interpreter 118 is acceptable. Responsive to the interpreter connection score exceeding the minimum quality connection score, the match server 115 at block 620 updates the status of the interpreter 118 having at least the minimum call quality score as “active”, and then ranks them from best to worst based on their relative score. The updates and rank are transmitted to the request assessment module at block 525.

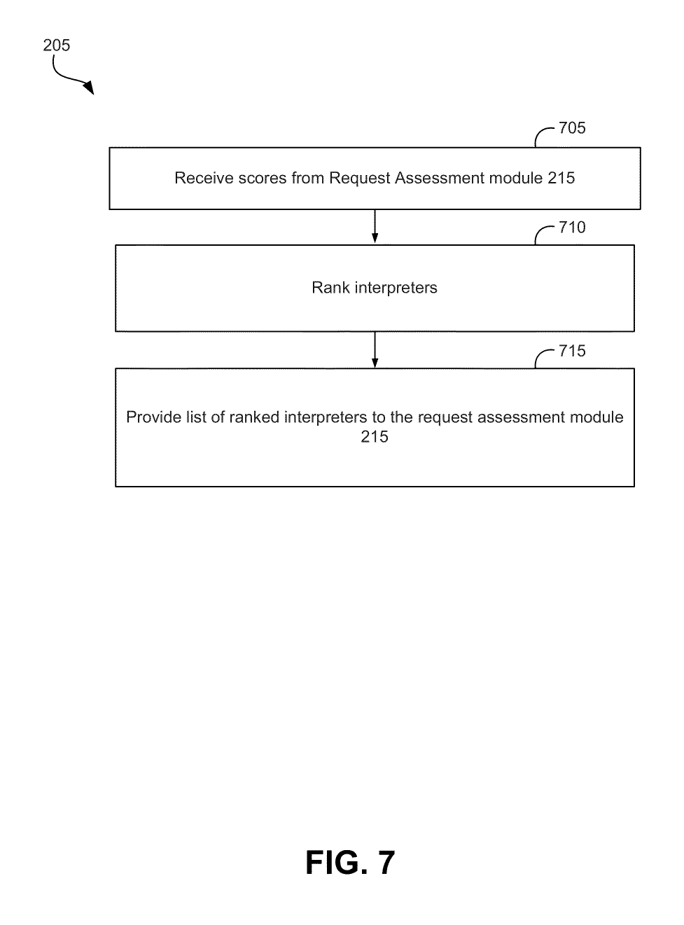

FIG. 7 is a more detailed flow diagram that illustrates an embodiment of the architecture, functionality, and/or operation of a product assessment module 205, such as that shown in FIG. 2. After service is completed, the product assessment module 205 at block 705 receives scores from the request assessment module 215 (FIG. 2) for every interpreter service that the requester 130 utilizes. Although the requester 130 may not score every interpreter service, the ones that the requester 130 does score is collected and analyzed to determine which interpreters 118 the requester 130 consistently scores highest for their specified skills. Using the appropriate algorithm for calculation, all past interpreters 118 used by the requester 130 are then ranked at block 710 based on the preference of the requester 130 using the scores provided. At block 715, this list is provided to the request Assessment Module 215.

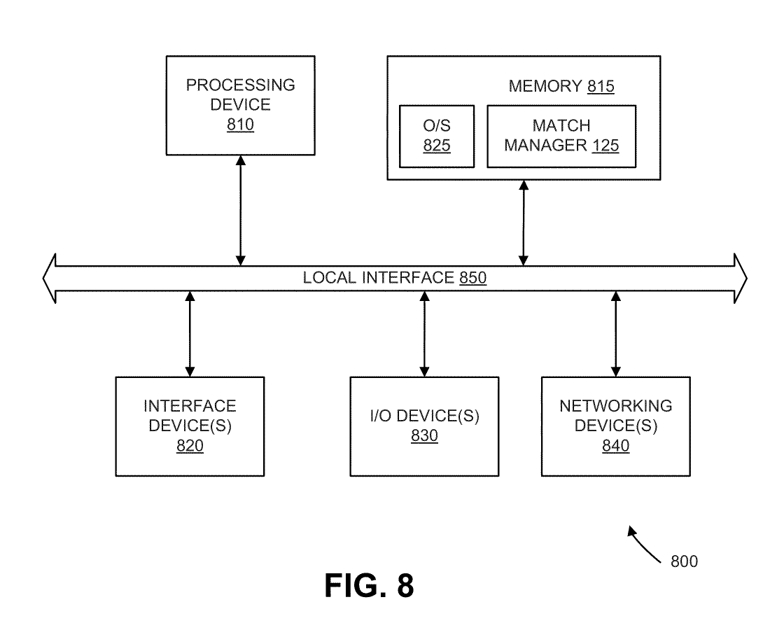

FIG. 8 is a block diagram illustrating an exemplary architecture for a generic computer 800 that is similar to the architecture of the computing devices 120, such as that shown in FIG. 1. As indicated in FIG. 8, the computing generic computer 800 comprises a processing device 810, memory 815, one or more user interface devices 820, one or more I/O devices 830, and one or more networking devices 840, each of which is connected to a local interface 850. The processing device 810 can include any custom made or commercially available processor, a central processing unit (CPU) or an auxiliary processor among several processors associated with the generic computer 800, a semiconductor based microprocessor (in the form of a microchip), or a macroprocessor. The memory 815 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 820 comprise those components with which the user (e.g., administrator) can interact with the generic computer 800. Where the generic computer 800 comprises a server computer or similar device, these components can comprise those typically used in conjunction with a PC such as a keyboard, mouse, touch sensitive graphic screen and visual gesture sensors.

The one or more I/O devices 830 comprise components used to facilitate connection of the generic computer 800 to other devices and therefore, for instance, comprise one or more serial, parallel, small system interface (SCSI), universal serial bus (USB), or IEEE 1394 (e.g., Firewire™) connection elements. The networking devices 840 comprise the various components used to transmit and/or receive data over networks (not shown), where provided. By way of example, the networking devices 840 include a device that can communicate both inputs and outputs, for instance, a modulator/demodulator (e.g., modem), a radio frequency (RF), infrared (IR), WiFi or cellular broadband (4G, LTE, 3G, etc.) transceiver, a telephonic interface, a bridge, a router, as well as a network card, etc.

The memory 815 normally comprises various programs (in software and/or firmware) including an operating system (O/S) 825 and the match manager 125 described above. The O/S 825 controls the execution of programs, and provides scheduling, input-output control, file and data management, memory management, and communication control and related services.

The systems and methods disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present disclosure includes embodying the functionality of the preferred embodiments of the present disclosure in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A telecommunication system that establishes communication between an interpreter and a requester comprising:
a plurality of computing devices associated with at least one interpreter and at least one requester;
a network that interconnects the plurality of computing devices; and
a match server that is interconnected to the plurality of computing devices by way of the network, wherein the match server includes a processing device; and memory including an match manager which has instructions that are executed by the processing device, the instructions including the following logics:
establish connection between the match server and the computing device associated with the interpreter;
assess a request for an interpreter having at least one language interpretation and for an availability of the interpreter; and
establish a telecommunication connection between the plurality of the computing devices associated with the interpreter and requester based on the connection established between the match server and the computing device associated with the interpreter, and the assessment of the request for the interpreter having the at least one language interpretation and for an availability of the interpreter.

2. The interpreter-requester match system as defined in claim 1, wherein the match manager has instructions that include the logic of:
assessing a network connection quality between the match server and the computing device associated with the interpreter; and
establishing the telecommunication connection between the plurality of the computing devices associated with the interpreter and requester is further based on the assessment of the network connection quality between the match server and the computing device associated with the interpreter.

3. The interpreter-requester match system as defined in claim 2, wherein the network connection quality is based on at least one of the following: internet connection speed and/or bandwidth quality (Mbps) between the computing device associated with the interpreter and an internet provider, and the distance between the computing device associated with the interpreter and a node of an internet provider.

4. The interpreter-requester match system as defined in claim 2, wherein the match manager has instructions that include the logic of assessing the connection quality between the match server and the computing device associated with the requester.

5. The interpreter-requester match system as defined in claim 4, wherein the logic of establishing the telecommunication connection between the plurality of the computing devices associated with the interpreter and requester is further based on the assessment of the network connection quality between the match server and the computing device associated with the requester.

6. The interpreter-requester match system as defined in claim 2, wherein the match manager has instructions that further include the logic of providing a list of interpreters based on the assessment of the network connection quality between the match server and the computing device associated with the interpreter.

7. The interpreter-requester match system as defined in claim 1, wherein the match manager has instructions that further include the logic of providing a scored and/or ranked list of interpreters based on past history between requester and interpreter.

8. The interpreter-requester match system as defined in claim 1, wherein the match manager has instructions that further include the logic of providing a list of interpreters based on a favorite list indication.

9. The interpreter-requester match system as defined in claim 1, wherein the match manager has instructions that further include the logic of providing a list of interpreters based on most frequently used interpreters.

10. The interpreter-requester match system as defined in claim 1, wherein the match manager has instructions that further include the logic of providing a list of interpreters based on a rating given by the requester to the interpreter.

11. The interpreter-requester match system as defined in claim 1, wherein the logic of establishing the telecommunication connection between the plurality of the computing devices associated with the interpreter and requester is accomplished by way of alerting the interpreter of the request for his service with a ring tone.

12. The interpreter-requester match system as defined in claim 1, wherein the match manager has instructions that further include the logic of updating the history of connection established between the requester and interpreter.

13. The interpreter-requester match system as defined in claim 1, wherein the match manager has instructions that further include the logic of updating the history of call quality, duration and rating associated with the connection established between the requester and interpreter.

14. The interpreter-requester match system as defined in claim 1, wherein the match manager has instructions that further include the logic of selecting the interpreter from the available interpreters based on updated history of call quality, duration and ratings associated with the connection established between the requester and interpreters.
